(19) United States
(12) Patent Application Publication
(10) Pub. No.: US 2010/0216539 A1
(43) Pub. Date: Aug. 26, 2010

(54) Reel and Rings Display Device

(76) Inventors: Jerald C. Seelig, Galloway, NJ (US); Lawrence M. Henshaw, Hammonton, NJ (US)

Correspondence Address: IAN F. BURNS & ASSOCIATES, 4790 Caughlin Parkway #701, RENO, NV, 89519-0907, US

(21) Appl. No.: 12/711,042

(22) Filed: Feb. 23, 2010

Related U.S. Application Data
(60) Provisional application No. 61/154,706, filed on Feb. 23, 2009.
(60) Provisional application No. 61/174,223, filed on Apr. 30, 2009.

(51) Int. Cl. A63F 9/24; A63F 13/00

(52) U.S. Cl. 463/20; 463/25; 463/30

(57) ABSTRACT

A gaming system includes a display for indicating a game outcome generated for a gaming device. The gaming display includes a central reel at the center of one or more ring displays. A game controller controls the reel and the ring displays to display arrangements of symbols that indicate the game outcome. A winning display of symbols may require at least one symbol on the rings that matches a symbol displayed on the reel. Each ring may be individually wagered so that a winning display requires symbols matching the reel symbol to be displayed in the wagered rings. Higher awards may be paid for particular patterns of matching symbols in the rings, for higher numbers of matching symbols in the rings, or for a higher number of rings having at least one matching symbol. The display may more easily indicate winning arrangements without the need for paylines.

### CROSS REFERENCE TO RELATED APPLICATIONS

This application claims priority to U.S. provisional patent application Ser. No. 61/154,706, filed on, Feb. 23, 2009 and 61/174,223, filed Apr. 30, 2009, the contents of which is herein incorporated by reference.

### FIELD OF THE INVENTION

The present invention relates to gaming systems and devices and in particular to gaming systems providing interesting and attractive bonus game displays.

### BACKGROUND

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number (hereinafter, both types are referred to as a “random number”).

The random number can be used to determine a game outcome. For example, the random number may then be compared to a predefined table to determine a corresponding outcome of the event. If the random number falls within a certain range of numbers on the table, the player may win the corresponding predefined prize. The table may also contain display information that allows the gaming device to generate a display that corresponds to the outcome of the game. The gaming device may present the outcome of the game on a large variety of display devices, such as mechanical spinning reels or video screens.

Some gaming devices award bonus prizes in addition to prizes that are awarded in a primary game. Of course, the prize in the primary game may simply be the opportunity to play the bonus game. A bonus prize is generally defined as a prize in addition to the prize obtained from the primary game and that is awarded to the player when a predefined event occurs. An example of a bonus game can be found in U.S. Pat. No. 5,848,932 to Adams. Adams discloses a primary game having three spinning game reels and a bonus game having a bonus display with one spinning wheel. The spinning wheel is divided into multiple sections, and each section has a symbol representing a prize. When predetermined indicia are displayed on the spinning game reels of the primary game, the wheel of the bonus display spins and stops. The bonus prize is displayed as the symbol on the wheel being pointed to by a pointer. The bonus prize is awarded in addition to any prizes awarded in the primary game. Another bonus game is disclosed in Baerlocher et al. (U.S. Pat. No. 6,336,863). Baerlocher et al. discloses a slot machine with a bonus award display. The bonus award display has a bonus wheel and a mechanical, movable pointer.

In other bonus game systems, bonus awards may be provided as a multiplier which multiplies the winnings of the primary game by an amount determined in the bonus game.

### SUMMARY OF ONE EMBODIMENT OF THE INVENTION

### Advantages of One or More Embodiments of the Present Invention

The various embodiments of the present invention may, but do not necessarily, achieve one or more of the following advantages:

provide a highly attractive and entertaining bonus game display;

provide a gaming display that does not require paylines to indicate a game outcome;

the ability to attract more patrons to play a game;

the ability to encourage players to play longer on a gaming apparatus; and

provide a bonus display that builds player excitement by allowing a player to anticipate a possible game outcome.

These and other advantages may be realized by reference to the remaining portions of the specification, claims, and abstract.

### Brief Description of One Embodiment of the Present Invention

In one aspect, the invention provides a display for a gaming device. The display may include a first display area configured to display an arrangement of a plurality of symbols. A second display area may display a second display area symbol. A winning game outcome may be indicated by the display. The winning game outcome may require at least one symbol in the arrangement of the first display area to match a symbol in the second display area.

In one aspect, the invention provides a display for a gaming device in which a central reel display is encompassed by one or more ring displays. The central reel may be selectively controlled to display a reel symbol and the ring displays may be selectively controlled to display an arrangement of symbols. A winning game outcome may be indicated if the symbol on the reel corresponds to a predetermined arrangement of symbols on the ring display(s).

In one aspect, the invention provides a method of playing a game comprising receiving a wager from a player into a gaming device and determining a game outcome. The game outcome may be displayed on a display. The display may comprise a symbol on a central display and an arrangement of a plurality of symbols on at least one ring of symbols around the central display. A winning arrangement of the plurality of symbols may require at least one symbol that matches the central display symbol.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic view of a network of gaming devices;

FIG. 2 is substantially a schematic view of a gaming device including a bonus game display;

FIG. 3 substantially depicts a game display in accordance with one embodiment of the invention;

FIG. 4 substantially depicts a method for playing a game including displaying a game outcome;

FIG. 5 substantially depicts a game display for use with multiple gaming devices; and

FIG. 6 substantially depicts a specific embodiment of the game display type of FIG. 5.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

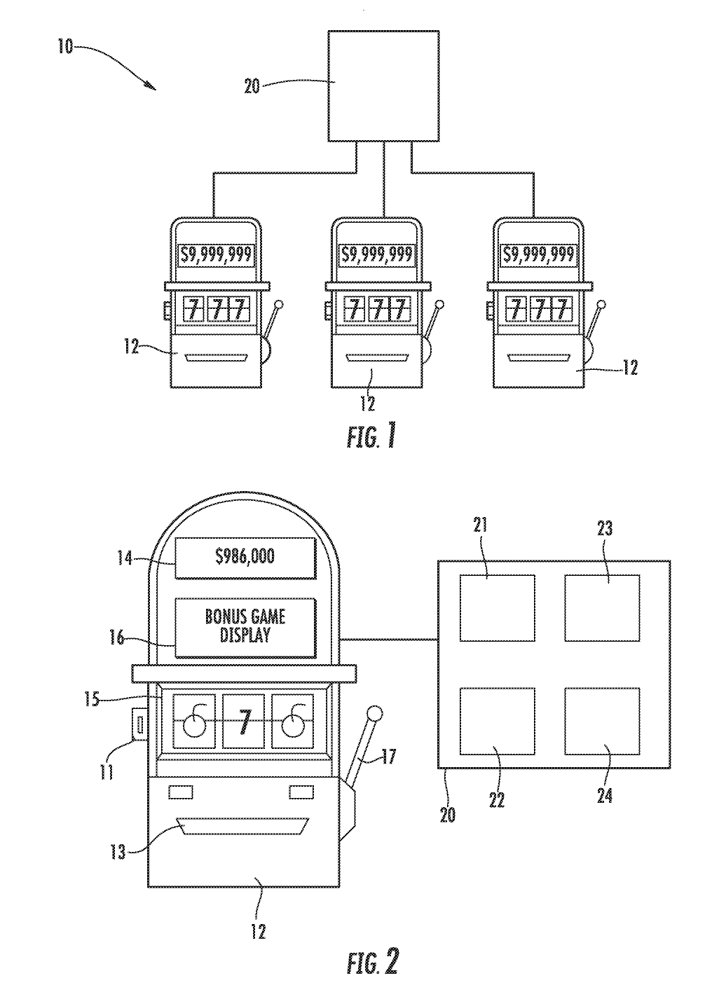

The present invention comprises a gaming device for a gaming system. As shown in FIG. 1, the gaming system 10 comprises at least one gaming device 12 that is configured to allow players to places wagers and play a game. Multiple gaming devices 12 may be networked within an establishment or within several establishments as is known in the art. An example of a gaming device 12, shown in more detail in FIG. 2, includes a value input device 11 such as a coin slot, bill acceptor, card reader, etc for receiving wagers including coins, tokens, membership cards or other types of debit cards. A payout slot 13 may be provided through which winnings may be paid or credits may be allocated to a player account such as a membership account or financial account. A player may play the gaming device 12 through a player input device 17 such as a handle, button, dial, keyboard, etc. A person skilled in the art will readily understand that the gaming device 12 is illustrative only and that many variants may be made. For example, the gaming device 12 may be configured to receive bills, casino tokens, credit cards or many other forms of payment. Similarly, winnings may be paid by tokens, tickets, credit or through other facilities of the gaming establishment.

A game display 15 displays a game outcome. The game display may include mechanical spinning reels, video reels, a poker card display or any other suitable game display apparent to the person skilled in the art. Additional displays 14 may display further game information, such as a progressive jackpot total. The game device 12 may also include a bonus game display 16 that may allow the player to play a bonus game or to receive bonus game information such as a bonus game outcome. The bonus game display 16 may be a display specifically configured for a particular bonus game. Alternatively the bonus game display may be a generic game display that can be configured by a game server using known server based game techniques. Details of bonus games that can be played using the bonus game display 16 will be described in greater detail below.

If server based gaming techniques are to be used, the gaming devices 12 may be operatively associated with a server 20, which may include components such as a processor 21, memory 22 and random number generator 23. While the random number generator 23 is shown as a distinct component, a person skilled in the art will readily understand that the random number generator 23 may be embodied within the processor 21. The server 20 may be provided within the vicinity of the gaming devices 12 or may be provided elsewhere in the gaming establishment and communicate with the gaming devices 12 through a communication link (not shown), as is known. In an alternative embodiment, the gaming device 12 may be self-contained such that the functions of the server, in particular the memory 22 and the random number generator 23, are provided from within the gaming device 12.

The control of a bonus game may be governed by a bonus game controller which may be the processor 21 at the server 20, a dedicated bonus game controller 24 at the server 20, or by a similar processor or bonus game controller within the gaming device 12.

Each of the gaming devices 12 are configured to operate a game program that allows players to place wagers and play games. The server 20 may store game programs and information, for example in memory 22, which can be downloaded to the gaming devices 12 and gaming devices 12 may transmit information to the server 20. A gaming device 12 may offer a plurality of different games. When a player selects one of the games, the selected game may be downloaded from the server 20 along with game related information, such as pay tables which may also be stored in memory 22. Pay tables are used to determine the outcome of each game and they control the odds of winning a game and the amounts paid out. The gaming devices 12 that form the network 10 may be in one location, such as a casino, or they may be in multiple locations such as an extended casino.

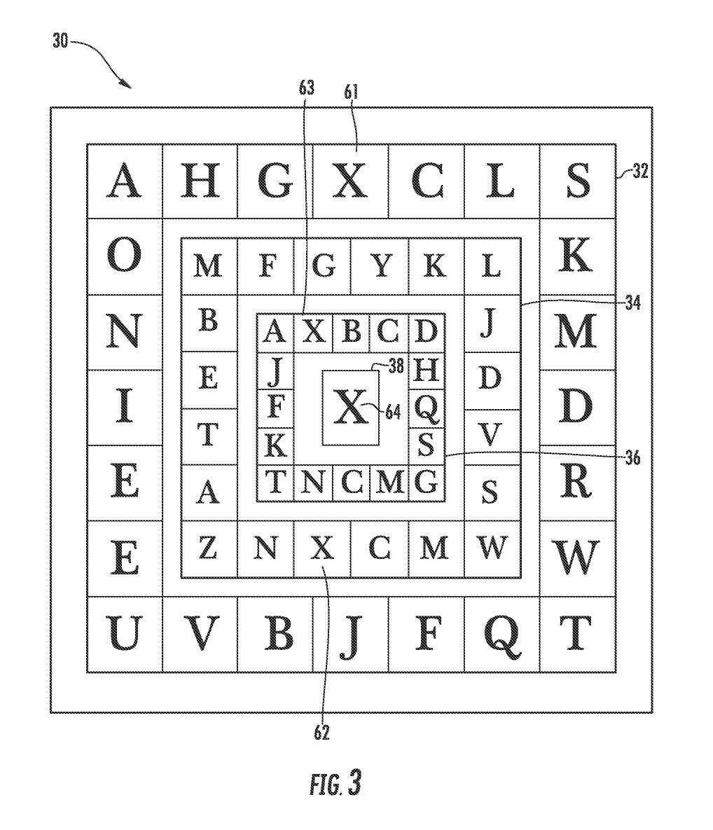

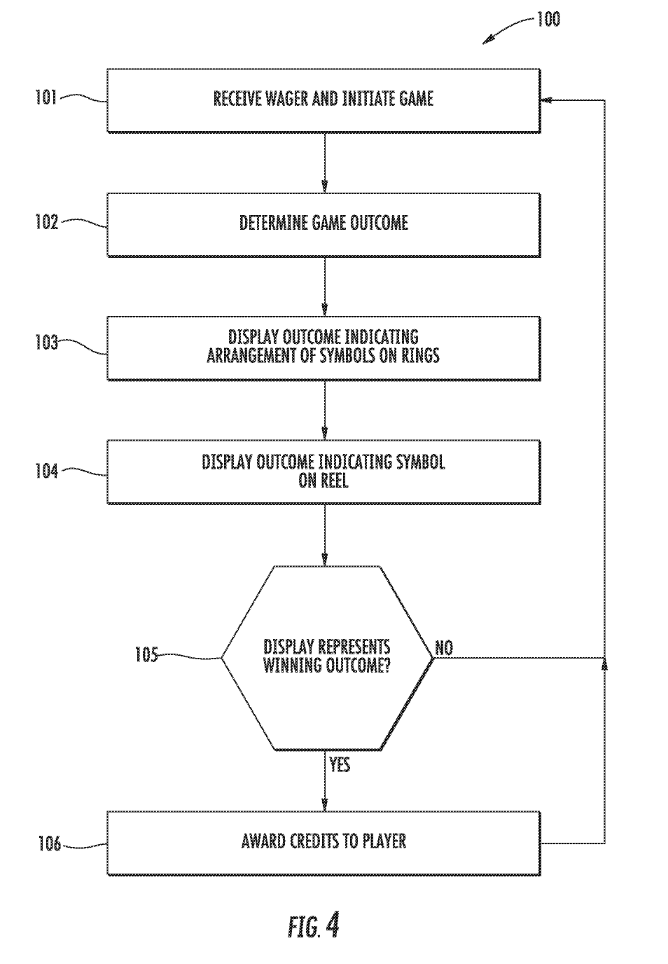

In one example of a typically gaming machine operation, when a player advances a wager and initiates a game, the random number generator 23 generates a random number which is then compared to the pay table to determine the gaming outcome. The display 15 is controlled to create a display, such as a combination of reels, that reflects the game outcome. As is known in the art, certain outcomes on a primary game of the gaming device 12 may trigger entry to a bonus game. An example of a bonus game is illustrated in FIG. 3.

A bonus game controller may control the bonus game display 16 to depict an arrangement of symbols that reflects the decided bonus game outcome.

In FIG. 3, there is shown a display device generally indicated as reference number 30. Display device 30 may be used with one gaming device or a plurality of gaming devices, such as in a community or group game, and it may be used as a primary game display 15 or bonus game display 16. Display device 30 may comprise a first display area for displaying a first arrangement of symbols. In the embodiment shown in FIG. 3, the first display area has an outer ring 32, a middle ring 34 and an inner ring 36. It is recognized that the present invention may utilize any number of rings and the rings may or may not be concentric rings as shown in FIG. 3. Each of the rings 32-36 are changeable display devices, such as video screens or light emitting diode displays, that have a plurality of symbol display positions or locations capable of displaying different symbols in the various symbol display positions. The symbols may be selected from an available set of symbols which may include letters, numbers, pictures, characters or a variety of graphics. Rings 32-36 may randomly display different symbols in different locations and the symbols may be made to dance, rotate or otherwise move in coordinated sequences.

Display device 30 also comprises a second display area. In the second display area, there is depicted a reel 38 positioned in the center of rings 32-36, i.e. the rings encircle or surround the reel 38. Reel 38 may be a video display or it may be a mechanical reel. Reel 38 is configured to display different symbols selected from a set of symbols available to the reel. Where the reel 38 is a mechanical reel, the available set of symbols on the reel 38 may correspond to, complement or otherwise match the available set of symbols for display on the video reels of the ring displays.

The display device 30 may also comprise a controller in communication with rings 32-36 and reel 38 that is adapted to cause these devices to generate various displays. The controller may be the server controller 20, if server based gaming techniques are used, or the controller may be internal to the gaming device incorporating the display 30.

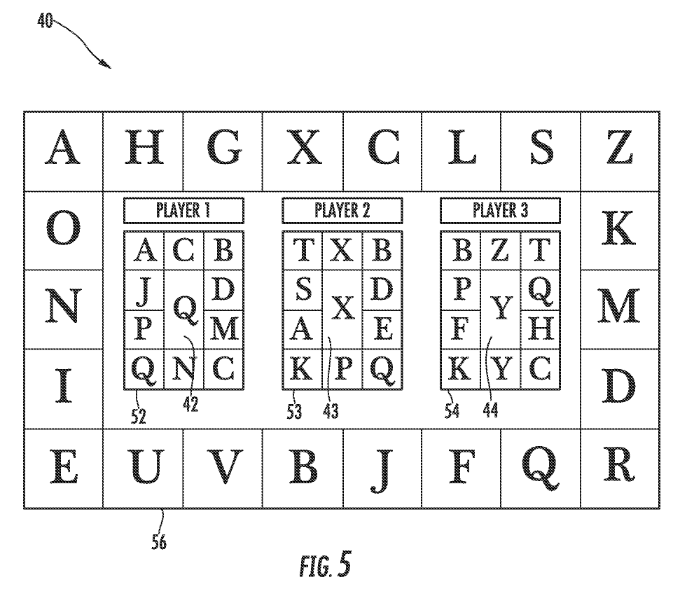

A method for playing a game using the display 30 is illustrated in the flowchart 100 of FIG. 4. In normal operation, a player would place a wager using the value input device 11 and initiate a game cycle (step 101) by activating a player input device 17, such as a button or a handle. The amount of the wager may determine a game outcome or the size of a prize that the player is awarded. Once a gaming cycle is initiated, the controller 20 utilizes a random number generator and a pay table to determine an outcome of the game (step 102). Controller 20 causes rings 32-36 to display various symbols in various locations as discussed above to indicate the game outcome (step 103) Controller 20 also causes reel 38 to move and stop so as to display a symbol in accordance with the outcome of the game (step 104).

In one embodiment, if the symbols displayed on the rings 32-36 and the symbol displayed on the reel 38 form a predetermined arrangement of symbols, i.e. a winning arrangement, as determined at step 105, then the player is awarded a prize corresponding to the predetermined arrangement (step 106). Play may then return to step 101 to initiate a new game cycle.

In a particular embodiment, a winning arrangement of symbols requires that one or more symbols displayed on rings 32-36 are the same or substantially the same as a symbol displayed on reel 38. For example, as shown in FIG. 3, the outer ring 32 displays an “X” symbol having reference number 61, middle ring 34 displays an “X” symbol 62 and inner ring 36 displays an “X” symbol 63. Since reel 38 also displays an X 64, the player has qualified to be awarded a prize. The amount of the prize may depend on the number of matching symbols displayed. For example, a player may receive three credits for three matching symbols or two credits for two matching symbols.

In one embodiment, only one matching symbol is displayed on a single ring and in another embodiment two or more matching symbols may be displayed on a single ring. In another embodiment, the player only wins a prize or wins a greater prize if the matching symbols form a line or fall on a predetermined line, such as a vertical, horizontal, diagonal or irregular line. In another embodiment, the player only wins a prize or wins a greater prize if the matching symbols form a predetermined pattern, such as a star or a cross. In yet another embodiment, the player is required to wager a predetermined amount for each ring that will be used to display the outcome. For instance, if one credit is required for each ring and the player wagers two credits, two of the three rings will be activated for the game or the player will only receive credit for symbols on two of the three rings.

In another embodiment, the process of selecting an outcome, spinning reel 38 and displaying symbols on rings 32-36 is repeated a plurality of cycles during a single game cycle. This may occur when a player receives a particular outcome in a primary game. For example, if a player receives a particular symbol that represents three cycles (e.g., a “3X” symbol), the process of selecting an outcome, spinning reel 38 and displaying symbols on rings 32-36 is repeated three times and the player is awarded the sum of any prizes that are awarded. In another embodiment, the player is given an option to repeat the process of selecting an outcome, spinning reel 38 and displaying symbols on rings 32-36. In this embodiment, the player may be charged a wager or fee for each time the process is performed. In another embodiment, the player is not charged for repeating the process but, the player is only awarded the last prize indicated by the display device 30. For example, if a player qualifies for three rounds and receives a good outcome the first round, the player may decide to not take the last two rounds in order to keep the outcome of the first round. If the player decides to take the second round, the outcome of the first round is waived and the player is awarded the outcome of the second round unless the player decides to take play the third round, in which case the player would receive only the outcome of the third round.

While the display device 30 has generally been described as providing a display device for a bonus game, as noted above, the display device 30 may also be used as the display 15 of for the primary game. In such an embodiment, a game controller which may be the server controller 20 shown in FIG. 2 or a game controller internal to the gaming device 10, is used to generate a primary game outcome and to control the display 15 to display the primary game outcome.

One of the advantages to this invention is that it is not necessary to use complicated and confusing pay-lines, such as those used on gaming devices that utilize multiple reels. Another advantage is that the display device can display many more symbols at one time than a device that only uses reels. Another advantage is that the display device is more flexible than reel-type display devices and more entertaining displays can be displayed.

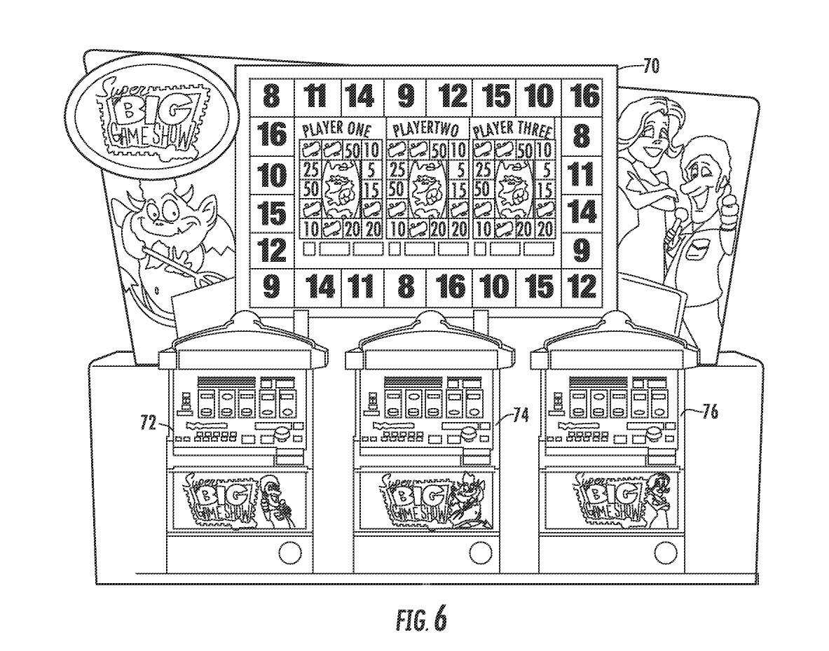

A further advantage is the ability to show game outcomes for a plurality of gaming devices on a combined display. In an alternative embodiment shown in FIG. 5, the display 40 is modified so that instead of the single reel 38 shown in FIG. 3, a plurality of reels are provided. A particular embodiment of the multiple display is shown in FIG. 6 in which the multiple display 70 is shown in conjunction with individual gaming devices 72, 74, 76.

In the example of FIG. 5, three reels 42, 43, 44 are shown with each reel being surrounded by one inner ring 52, 53, 54 and the three reels and the inner rings being surrounded by an outer ring 56. Each reel, e.g. reel 42 and corresponding inner ring e.g. ring 52 may be associated with an independent gaming device 10 while the outer ring 56 can be utilized by any of the gaming devices to display a game outcome. In one embodiment, a gaming controller 20 can display gaming outcomes for each of the gaming devices linked to the display 40, for example, by controlling the reel 42, corresponding inner ring 52 and the outer ring 56 to display a combination of symbols that constitutes a winning outcome for the associated gaming device. With this type of display 40, there may be times where the gaming controller is required to simultaneously show a winning game outcome for multiple gaming devices. In such circumstances, the gaming controller can display a winning outcome to a first gaming device using a first arrangement of symbols with a first symbol type, e.g. an “X” symbol, and can show a second winning outcome to a second device with a second symbol type, e.g. a “Y” symbol type. By selecting different symbol types for displaying the first and second game outcomes, the game outcomes can be simultaneously displayed, in particular on the outer ring 56, without confusion between the gaming outcomes.

While the rings depicted herein are generally square or rectangular, the rings may be provided in any particular shape or configuration such as a circular, triangle, or irregular shape. In addition, each ring may have a different shape in order to provide for more attractive and artistic displays.

In various embodiments, the ring display and reel display may be displayed simultaneously. In alternative embodiments, the ring display may be displayed first prior to the depiction of the reel being spun. This enhances player excitement because a player may view the ring display and predict various outcomes for the reel that will produce winning outcomes. For example, where the ring symbols form a pattern that pays a high award, the player can anticipate obtaining the reel symbol required to earn the award. In alternative embodiments, the rings may be displayed sequentially, e.g. from the outer ring inwards to the inner ring and reel, or the reel may be displayed then the rings outwardly from the inner ring to the outer ring.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A gaming system comprising:
(A) a gaming device configured to allow a player to place a wager and select to play a game;
(B) a game controller;
(C) a game display;
(D) wherein the game display comprises:
(a) a first display area comprising a plurality of symbol display positions configured to display an arrangement of a plurality symbols; and
(b) a second display area configured to display a second display area symbol; and
(E) wherein the game controller is configured to:
(a) determine a game outcome in response to a player selection to play a game, the game outcome comprising a winning outcome or a non-winning outcome;
(b) generate an arrangement of symbols to represent the game outcome; and
(c) control the game display to represent the game outcome; and
(d) wherein a winning arrangement of symbols to represent a winning outcome comprises a first display area arrangement of symbols that matches a symbol for the second display area.

2. The gaming system of claim 1 wherein the first display area comprises at least one ring encompassing the second display area, each of the at least one rings comprising a plurality of symbol positions configured to display a plurality of symbols.

3. The gaming system of claim 2 wherein at least one winning arrangement of symbols to represent a winning outcome comprises at least one symbol in the at least one ring that matches the symbol displayed in the second display area.

4. The gaming system of claim 3 wherein the winning arrangement of symbols to represent a winning outcome comprises a predetermined pattern of symbols in the at least one ring that match the symbol displayed in the second display area.

5. The gaming system of claim 2 wherein the first display area comprises a plurality of rings encompassing the second display area, each of the plurality of rings comprising a plurality of symbol positions configured to display a plurality of symbols.

6. The gaming system of claim 5 wherein the winning arrangement of symbols to represent a winning outcome comprises at least one symbol in at least one of the plurality of rings that matches the symbol displayed in the second display area.

7. The gaming system of claim 5 wherein the winning arrangement of symbols to represent a winning outcome comprises at least one symbol that matches the symbol displayed in the second display area in each of the plurality of rings.

8. The gaming system of claim 5 wherein at least one winning arrangement of symbols to represent a winning outcome comprises a predetermined pattern of symbols displayed across the plurality of rings.

9. The gaming system of claim 5 wherein the gaming device is configured to allow the player to select one or more rings of the plurality of rings to place a wager on, wherein a winning arrangement of symbols to represent a winning outcome requires at least one symbol matching the symbol displayed in the second display area to be displayed in the one or more rings selected by the player.

10. The gaming system of claim 2 wherein the second display area comprises a video reel or a mechanical reel.

11. The gaming system of claim 10 wherein the game controller is configured to control the video reel or mechanical reel to display a symbol that matches a winning arrangement of symbols of the first area display if the game outcome comprises a winning outcome.

12. The gaming system of claim 1 wherein the game controller is configured to control the second display area to depict a reel that stops on a second display area symbol selected by the game controller.

13. The gaming system of claim 1 comprising:
(A) a plurality of gaming devices; and
(B) wherein the display comprises:
(a) at least one first display area for each gaming device;
(b) at least one second display area for each gaming device; and
(c) at least one third display common to the plurality of gaming devices.

14. The gaming system of claim 13 wherein the game controller is configured to:
(A) control the game display to represent a winning game outcome for at least one of the plurality of gaming devices; and
(B) wherein a representation of a winning game outcome comprises at least one symbol in the third display area that matches a symbol of the at least one second display area of the respective gaming device.

15. The gaming system of claim 13 wherein the at least one first display area comprises at least one inner ring, wherein the at least one second display area comprises a reel disposed within the at least one inner ring, and wherein the at least one third display area comprises at least one outer ring disposed around all of the at least one inner rings.

16. A method of playing a game comprising:
(A) receiving a wager from a player into a gaming device;
(B) determining a game outcome; and
(C) displaying the game outcome on a display comprising:
(a) displaying a symbol on a central display; and
(b) displaying an arrangement of a plurality of symbols on at least one ring of symbols around the central display, wherein a winning arrangement of the plurality of symbols representing a winning game outcome requires at least one symbol that matches the central display symbol.

17. The method of claim 16 comprising awarding a credit to the player for a winning game outcome, wherein the value of the award is higher for a correspondingly higher number of matching symbols in the at least one ring.

18. The method of claim 17 comprising awarding a higher credit to the player if the winning arrangement of the plurality of symbols form a predetermined pattern of symbols that match the central display symbol.

19. The method of claim 16 comprising displaying the arrangement of the plurality of symbols on a plurality of rings around the central display wherein the winning arrangement of the plurality of symbols requires at least one symbol that matches the central display symbol in at least one of the plurality of rings.

20. The method of claim 19 comprising displaying the arrangement of the plurality of symbols on a plurality of rings around the central display wherein the winning arrangement of the plurality of symbols requires at least one symbol that matches the central display symbol in each of the plurality of rings.

21. A display for a gaming device comprising:
(A) a reel configured to selectively display one of a plurality of symbols; and
(B) at least one ring configured to selectively display an arrangement of a plurality of symbols around the reel.

22. The display of claim 21 comprising a plurality of rings disposed around the reel.

23. The display of claim 21 comprising:
(A) a plurality of inner rings;
(B) a plurality of reels, each reel disposed inside of an inner ring; and
(C) at least one outer ring disposed around the plurality of inner rings.

24. A gaming system comprising:
(A) means for allowing a player to place a wager and select to play a game;
(B) means for generating a winning game outcome;
(C) means for displaying a first portion indicating a winning game outcome; and
(D) means for displaying a second portion indicating the winning game outcome.

25. The gaming system of claim 24 comprising means for displaying a third portion indicating a winning game outcome.
